(19) United States
(12) Patent Application Publication
(10) Pub. No.: US 2010/0238664 A1
(43) Pub. Date: Sep. 23, 2010

(54) AMBIENT LIGHT USING SWITCHABLE CANVAS

(75) Inventor: Wilhelmus Theodorus, Maria Steenbergen, Geldrop (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 12/294,628

(22) PCT Filed: Mar. 27, 2007
(86) PCT No.: PCT/IB2007/051079

§ 371 Date: Sep. 26, 2008

Related U.S. Application Data
(60) Provisional application No. 60/788,475, filed on Mar. 31, 2006.
(60) Provisional application No. 60/882,030, filed on Dec. 27, 2006.

(51) Int. Cl. G09F 13/00; G02B 5/02; F21V 3/04

(52) U.S. Cl. 362/276; 359/599; 362/311.01

(57) ABSTRACT

A display system includes a unit configured to provide information, and a plate extending away from the unit in at least one direction. The plate is configured to receive input light and to provide ambient light that may be related to the information. In response to voltage levels, the plate is substantially transparent in a transparent mode and substantially light scattering in a scattering mode to provide the ambient light.

The present invention relates to systems and methods that produce ambient lighting effects. More particularly, it relates to units having a switchable canvas for output, e.g., reflection, of ambient light.

Philips Electronics and other companies have disclosed means for changing ambient or peripheral lighting to enhance video content for typical home or business applications. Ambient lighting added to a video display or television has been shown to reduce viewer fatigue and improve realism and depth of experience. Currently, Philips Electronics has a line of flat panel televisions (Flat TVs) with ambient lighting, where a frame around the Flat TV includes ambient light sources that project ambient light on the back wall that supports or is near the Flat TV. Projecting ambient light on the back wall works very well, as long as the color of the wall is a white (or a light neutral shade, but not glossy white), the distance to the wall is relatively short, and there are no obstacles between the ambient light source and the wall. Further, the back wall should be parallel to the Flat TV to have the same ambient light impressions to the left and right (as well as top and bottom) of the Flat TV screen. If the Flat TV is too far away from the back wall, then the visibility of the light spot on the back wall decreases dramatically. Further, if the Flat TV is not parallel enough to the back wall, then the light spot is bigger and less intense on the side that is further away from the wall.

Thus, proper effect from the ambient light source of televisions requires a robust environment, such as a proper wall color, distance and obstacle free environment between the back wall and the TV. Accordingly, there is a need for an ambient light system that provides desired ambient light effects substantially independent of the environment yet is not obtrusive.

It is an object of the present system to overcome disadvantages and/or make improvements in the prior art.

This and other objects are achieved by devices and methods comprising a display system that includes a unit configured to provide information, and a canvas or plate extending away from the unit in at least one direction. The plate is configured to receive input light and to provide, e.g., reflect, ambient light that may be related to the information. In response to voltage levels, the plate is substantially transparent in a transparent mode and substantially light scattering in a scattering mode to provide the ambient light.

Since the canvas is substantially transparent and invisible, e.g., when the TV is switched off, the TV set is less obtrusive and does not appear to be large. Further, such a device, e.g., TV, with the switchable canvas, provides proper ambient light effects (e.g., when turned on) independent of its environment or positioning of the TV with respect to a back wall and/or independent of the wall properties, such as color and reflectance, including independent of the distance from the TV to the back wall and the orientation of the TV relative to the back wall.

Further areas of applicability of the present systems, devices and methods will become apparent from the detailed description provided hereinafter. It should be understood that the detailed description and specific examples, while indicating exemplary embodiments of the display units and methods, are intended for purposes of illustration only and are not intended to limit the scope of the invention.

These and other features, aspects, and advantages of the systems, apparatus and methods of the present invention will become better understood with regard to the following description, appended claims, and accompanying drawings where:

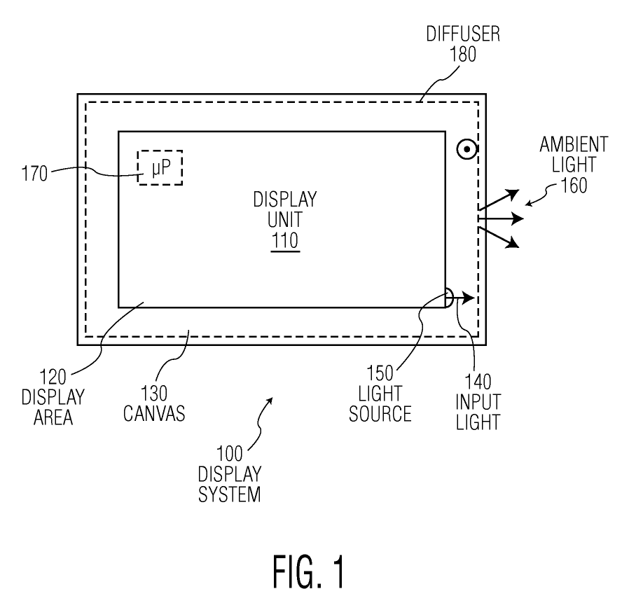

FIG. 1 shows a frontal view of a display system according to an illustrative embodiment of the present system; and

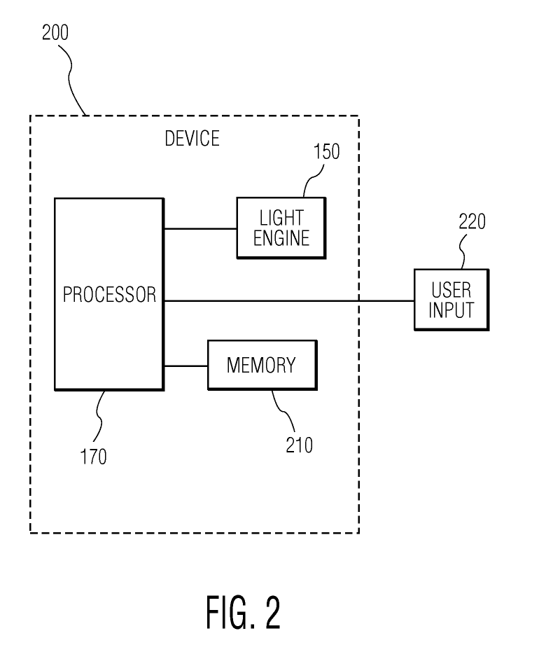

FIG. 2 shows a schematic diagram of a device, such as a television, in accordance with an illustrative embodiment of the present system.

The following description of certain exemplary embodiments is merely exemplary in nature and is in no way intended to limit the invention, its application, or uses. In the following detailed description of embodiments of the present systems, devices and methods, reference is made to the accompanying drawings which form a part hereof, and in which are shown by way of illustration specific embodiments in which the described devices and methods may be practiced. These embodiments are described in sufficient detail to enable those skilled in the art to practice the presently disclosed systems and methods, and it is to be understood that other embodiments may be utilized and that structural and logical changes may be made without departing from the spirit and scope of the present system.

The following detailed description is therefore not to be taken in a limiting sense, and the scope of the present system is defined only by the appended claims. The leading digit(s) of the reference numbers in the figures herein typically correspond to the figure number, with the exception that identical components which appear in multiple figures are identified by the same reference numbers. Moreover, for the purpose of clarity, detailed descriptions of well-known devices, circuits, and methods are omitted so as not to obscure the description of the present system.

The various embodiments described herein emit ambient light to an ambient space about a flat panel television (or any other content providing device) using active or passive light. However, any type of a video display unit or other units may be used, such as other type of televisions, display devices, monitors or the like. Other types and sources of information may also be used instead of video content and a video display unit, including audio and multimedia content, devices, or the like. Therefore, without limiting the applicability of the invention to a flat panel television, the invention will be described in such an environment. It should also be noted that the particular arrangement and configuration of elements shown in the figures are by way of example only, and not intended to limit the scope of the invention in any way. Other embodiments and modification would be apparent to those skilled in the art in view of the disclosure herein.

Referring now to FIG. 1, there is shown a frontal view of a flat panel television or display system 100 according to an illustrative embodiment of the present system. It should be understood that the figures are not drawn to scale, and any relative changes in dimensions are envisioned herein. The display system 100 includes a display unit 110 having a display area 120 configured to display video information. A switchable plate or canvas 130 surrounds the display unit 110 that, when ON or in a scattering mode, scatters ambient light synchronized with the displayed content. When OFF, the switchable canvas 130 is transparent and thus becomes substantially invisible.

Illustratively, the display unit 110 is an LCD (Liquid Crystal Display) or PDP (Plasma Display Panel) flat television. However, the display unit or monitor 110 may be of any type and use any technology or platform, such as CRT (Cathode Ray Tube), FED (Field Emission Display), projection displays, thin-film printed optically-active polymer displays, or displays using any other technologies or displays, including displays of mobile devices, such as mobile phone, personal digital assistants (PDA), music players and the like. It is even applicable, for many embodiments, to any transmissive medium for the delivery of video or visual information, such as found in a window of a building. For clarity of discussion, video displays shall be used here for illustrative purposes. Further, instead of a display unit, any other electronics unit, with or without a display, may be surrounded by the switchable canvas 130 to provide an ambient light effect, such as music players and the like, where the ambient light is synchronized with the music being played.

Optionally, a frame or bezel may also be provided to surround the display unit or TV 110 and holds parts of the TV together, for example. Illustratively, the frame may be a metal rim that surrounds and is part of the LCD or TV unit 110. Typically for an LCD panel 110, there is no pixel light behind this metal frame which keeps the separate parts of the LCD display together. In principle, all displays have an area around the active video display area 120 where no video content or pixel light is generated. For example, instead of the metal frame typically present for LCD displays, a PDP typically has a seal area around the PDP glass with connection foils where there is no pixel light. Nevertheless, in the case where pixel light is available at frontal edges the display, the frame can be made of a number of commonly available transparent or translucent materials that allow optical communication of the pixel light to the switchable canvas 130. Such transparent or translucent materials include clear plastics like Lexan®, Lucite®, and many other polymer resins, such as PET and ABS resin, and formed using known fabrication techniques. Any material can be used that has requisite mechanical and/or optical properties for a frame capable of supporting the TV or monitor 110. If desired, the frame may also be of the type which is capable of allowing optical communication, such as allowing passage of pixel light (as input light 140 for example) to the switchable canvas 130.

The display unit 110 is encased or surrounded (e.g., peripherally,) by the switchable canvas 130 to broadcast ambient light 160 into an ambient space. The switchable canvas 130 may be a transparent in the OFF or transparent state and thus substantially invisible. It should be understood that the switchable canvas 130 may also be semi-transparent, opaque or the like in the OFF state if desired. However, as will be apparent, it is more desirable to use a switchable canvas 130 which is transparent in the OFF state. Nevertheless, the plate 130 can embody various diffuser effects to produce light mixing, as well as translucence or other phenomena, such as a frosted or glazed surface; or ribbed glass or plastic; or apertured structures, such as by using metal or other internal blockers, depending on the visual effect desired.

The switchable canvas 130 is configured to receive input light 140 provided by a controlled light source 150 and scatter the input light 140 as ambient light 160, shown as arrows and a dot in a circle indicating the ambient light 160 is directed toward sides of the TV 110 and/or towards a viewer of the TV 110. Alternatively or in addition to the light source 150, the input light 140 may also be provided directly from the content or pixels displayed at edges of the display area 120 and coupled to the switchable canvas 130 for output as the ambient light 160.

The ambient light 160 may follow, e.g., change colors, hues, saturation, brightness and/or intensity to follow, the content of the picture displayed on the TV 110, such as the video displayed near the periphery of the TV 110, e.g., under the control of a processor 170 which may be configured to perform content analysis to extract light attributes (e.g., color, hue, saturation, intensity, etc.) of the content displayed on the display area 120. Of course, the processor 170 may be configured to analyze light attributes of the content displayed at edges of the display area 120 and control one or more light sources 150 to provide the input light 140 having light attributes that match the analyzed content and is synchronized therewith.

Further, the processor 170 may also be configured to execute predetermined light scripts provided with the information or content displayed on the display area 120, or provided from another source, such as a memory or downloaded from the Internet for example. The predetermined light scripts may be associated and synchronized with the displayed content, or may be any other predetermined script, such as an action script, romantic script, relaxing script and the like.

Thus, the ambient lighting content may be received in a form of a light script that is produced internal or external to the system, such as disclosed in International Patent Application Serial No. IB2006/053524 (Attorney Docket No. 003663) filed on Sep. 27, 2006, which claims the benefit of U.S. Provisional Patent Application Ser. Nos. 60/722,903 and 60/826,117, all of which are assigned to the assignee hereof, and the contents of all which are incorporated herein by reference in their entirety.

In one embodiment, the light script is produced external to the system, for example by a light script authoring service that provides a light script related to particular video content. The light script may be retrieved from an external source accessible, for example, from a wired or wireless connection to the Internet. In this embodiment, video content or a memory medium bearing the video content may include an identifier for the content. The identifier may be utilized to retrieve a light script that corresponds to the video content.

In another embodiment, the video content may be processed to produce the ambient lighting data related to the video content. The processing, in a form of analyzing the video content or portions thereof, may be performed just prior to rendering the video content or may be performed on stored or accessible video content.

PCT Patent Application WO 2004/006570, filed on Jun. 23, 2003, published on Jan. 15, 2004, entitled “Method of and System for Controlling an Ambient Light and Lighting Unit” and assigned to the assignee hereof, the contents of which are incorporated herein by reference in their entirety, discloses a system and device for controlling ambient lighting effects based on color characteristics of rendered content, such as hue, saturation, brightness, colors, speed of scene changes, recognized characters, detected mood, etc. In operation, the system analyzes received content and may utilize the distribution of the content, such as average color, over one or more frames of the video content or utilize portions of the video content that are positioned near a border of the one or more frames to produce ambient lighting data related to the video content. Temporal averaging may be utilized to smooth out temporal transitions in the ambient lighting data caused by rapid changes in the analyzed video content. Further, pixels of the video content may be analyzed to identify pixels that provide a coherent color, while incoherent color pixels are discarded. The coherent color pixels are then utilized to produce the video-based ambient lighting data, as disclosed in International Patent Application Serial No. IB2006/053524 (Attorney Docket No. 003663).

Instead of being a single switchable canvas 130 located all around the display unit, e.g., the LCD panel or TV 110, such as being integrated with and totally encasing or surrounding the TV 110 or being disposed behind the display unit 110, the switchable canvas 130 may partially encase or surround the TV or display unit 110 in at least one direction (such as above and/or below, and/or to the right and/or left of the TV 110). Alternatively, the switchable canvas 130 may be part of a separate stand alone light scatterer mechanically and optically coupled to the TV 110 or any other unit or frame surrounding a unit, or coupled to any other source of information or devices, including video, audio, multimedia or the like.

The stand alone switchable canvas 130 may have its own controllable light source(s) for providing input light 140 to be scattered from the switchable canvas 130 as ambient light 160. Such a stand alone switchable canvas 130 may be retrofitted on existing TV's for example, or on any other unit or on a frame of any unit, and may have portions that are contoured to the shape of existing TV's for easy attachments so that at least one transparent plate extends away from the TV in at least one direction for providing ambient light 160 in a desired direction.

Similar to the integrated system, the stand alone switchable canvas 130 may be attached substantially adjacent to the TV 110 and/or be disposed behind the TV 110. Of course, the stand alone switchable canvas 130 may also partially or totally encase or surround the TV 110, similar to the embodiment where the switchable canvas 130 is integrated with the TV 110.

Illustratively, the switchable canvas 130 extends away from the center of the TV 110 in all four directions for providing illumination/ambient light 160 including from the corners between the four directions, for example, to form a rectangular, square or any other desired shape, such as a circle, oval, octagon, pentagon, free-form or the like. Alternatively, the switchable canvas 130 extends away from the TV 110 in the right and left directions, or up and down directions, for example. The switchable canvas 130 is configured to receive the input light 140 and to provide the ambient light 160.

Illustratively, the switchable canvas 130 is Polymer Dispersed Liquid Crystal (PDLC). As is well known, PDLCs operate on the principle of electrically controlled light scattering. They include liquid crystal droplets surrounded by a polymer mixture sandwiched between two pieces of conducting glass. When no electricity is applied, e.g., the PDLC is connected to ground, i.e., the scattering state, the liquid crystal droplets are randomly oriented, creating an opaque state that scatter light, in this case, as ambient light 160. When a voltage is applied, i.e., the transparent state, the liquid crystals align parallel to the electric field and become transparent where light passes therethrough. Illustratively, the applied voltage is approximately in the range of 5-200 volts. PDLC panels may also be used for windows, such as Polyvision™ panels from Polytronix, Inc. of Texas, which transform from a cloudy white translucent barrier to an optically clear or transparent state when a voltage is applied to the panels. The panels may be produced by laminating polymer-dispersed liquid crystal film between two layers of glass.

As desired, light guides and/or interruptions/bubbles that are invisible to the naked eye may be provided to guide the input light 140 to better reflect and scatter the ambient light 160 toward a front of the TV 110, for example, toward a viewer. Of course, ambient light can also be guided toward the back of the LCD panel 110 to exit as back spill and illuminate a back wall for example. A switchable diffuser 180 may also be provided behind the switchable canvas 130 to better diffuse and scatter light for exit as the ambient light 160. In response to application or lack of a proper voltage, the switchable diffuser 180 may also switch between a transparent state and a scattering or diffusion state where it turns opaque and/or reflective, for example.

Illustratively, the diffuser 180 is transparent in the one state when no voltage is applied, and switched to a diffusing state when a voltage is applied to the diffuser 180. The diffuser 180 may also be a PDLC which is configured to further diffuse the ambient light. In addition, or instead of the diffuser 180, a switchable reflective coating may also be provided behind the PDLC layer 130 to enhance the reflectance of the ambient light 160 toward the viewer. The switchable reflective coating is also switchable between transparent and reflective states based on the presence or lack of a voltage applied thereto. Any suitable switchable diffuser may be used, such as for example using Cholesteric Texture Liquid Crystal (CTLC) technology related to reflective switchable solution. Alternatively or in addition, the diffuser may not be switchable between the transparent and diffusing states, and rather be a transparent plate having substantially invisible interruptions made by printing, and/or bubbles having any desired 3-dimensional shape and made with a laser in a transparent glass or plastic plate, for example. The interruption and/or bubbles may be configured to direct the ambient light in any desired direction, including reflection thereof toward the viewer, as described in U.S. Provisional Patent Application Ser. No. 60/713,184 (Docket US002308), filed on Aug. 31, 2006, entitled “Ambient Lighting Trough Transparent Materials” which is assigned to the assignee hereof, and the contents of which are incorporated herein by reference in their entirety.

The display system 100 further includes the controllable light source 150 configured to provide input light 140 to the switchable canvas 130 for exit as the front, back and/or side ambient light 160. The light source 150 may be located either in the TV or LCD panel 110, or is part of the switchable canvas 130, for example.

The light source 100 may be any illumination system that provides changing colors, hues, saturation and/or intensity. For example, the light source 150 may include red, green and blue light emitting diodes (LEDs) separately controllable to provide desired characteristics such as color mixing, hues, saturation and/or intensity. Alternatively or in addition, the light source 150 may include any other type of light source(s), alone or in combination, such as incandescent, gaseous discharge, fluorescent, phosphorescence, laser, photo-luminescent, electro-luminescent, cathode-luminescent, galvano-luminescent, crystallo-luminescent, kine-luminescent, thermo-luminescent, tribo-luminescent, sono-luminescent and/or radio-luminescent sources, as described in International Publication No. WO 2005/062608 A2, (Docket NL031504), entitled “Supplementary Visual Display System”, filed on Dec. 20, 2004, published on Jul. 7, 2005, and assigned to the assignee hereof, the contents of which are incorporated herein by reference in their entirety.

The light source 150 (and consequently the input light 140) may be controlled by a processor 170 shown as dashed lines in FIG. 1, in response to the content information displayed on the video display unit such as the LCD panel 110, such as via RF signals received by the LCD panel 110, or video signals derived from the RF signals using modulators or other circuits needed for such controlled operation, as described in the above noted International Publication No. WO 2005/062608 A2, (Docket NL031504); and as described in International Publication No. WO 2006/003603 A2, (Docket U5040282), filed on Jun. 27, 2005, published on Jan. 12, 2006, entitled “Passive Diffuser Frame System for Ambient Lighting Using a Video Display Unit as a Light Source” and assigned to the assignee hereof; as well as described in International Publication No. WO 2006/003604 (Docket U5040283), filed on Jun. 27, 2005, published on Jan. 12, 2006, entitled “Active Frame System for Ambient Lighting Using a Video Display as a Signal Source”, and assigned to the assignee hereof, the contents of all of which are incorporated herein by reference in their entirety. Accordingly, the ambient light 160 will be related to, and/or derived from, the content displayed on LCD panel 110 under the control of the processor 170.

As described in the above noted International Publication No. WO 2005/062608 A2, (Docket NL031504), the processor 170 may be configured to control the light source(s) 150 to provide ambient light 160 that follows color and intensity of the content displayed on the TV 110, especially the edges of the display region. For example, in response to a beach scene with blue skies and yellowish sand (at the bottom of the display region), the ambient light from the top potion of the switchable canvas 130 will be bluish, while the ambient light from the bottom potion of the switchable canvas 130 will be yellowish. The colors and intensities of the ambient light may be graduated spatially, such as becoming less blue and less intense further away from the top of the display area of the TV 110 showing a blue sky, and may eventually become closer to the color of nearby walls or room furniture/accessories/lighting, thus providing a blending effect. Thus for example, ambient light from the extreme lateral edges of the switchable canvas 130 furthest away from the center of the TV 110, may follow or track room illumination and wall color immediately behind the TV 110, as detected by sensors for example, and seen as background by the viewer.

Alternatively, the processor 170 may be configured to control the light source(s) 150 to provide the ambient light 160 in response to the surrounding conditions as measured via sensors, such as the color any surrounding wall, the color and intensity of room lighting and the like. A user interface 220 (FIG. 2), such as via the remote control of the TV 110, may be provided to allow the user to chose various modes, including selecting or switching ON/OFF portions or panels of the switchable canvas 130 for providing ambient light, in the case where the switchable canvas 130 includes separately controllable panels. For example, the user may select to disable or switch the lower panel to the transparent mode so that no ambient light is provided from the lower portion of the switchable canvas 130. The user interface 220 may be used to change the default mode which may be, for example, switching the canvas 130 to the scattering mode to provide the ambient light 160 when the TV is ON, and switching the canvas 130 to the transparent mode when the TV is OFF.

The user may also control the mode of the ambient light, such as having the ambient light follow the displayed content, or be responsive to room lighting condition, or even have a manual mode to provide any desired color or color combination. Of course, predetermined ambient modes may also be included, such as an action mode, a romantic mode etc., where the ambient light may be any predetermined color combination, intensities, hues, and/or saturation, and is provided in any desired, predetermined, and/or user controllable or user-programmable sequence. One mode may be a disco mode or action mode, as described in the above noted International Publication No. WO 2005/062608 A2, (Docket NL031504), where the light source(s) 150 may include discharge tubes such as xenon one, or strobe type light source, to provide bright flashes of light for special effects, such as explosions, thunder or the like. In such cases, the processor 170 is configured to control the light source(s) 150 in response to audio signals of the content, where audio sensors may be used to monitor, detect and/or analyze audio content. The audio content or signal may be monitored directly by the processor or by any other suitable sensors.

The switchable canvas 130 may be part of a stand-alone unit that may include the processor 170 or a further processor. The light source(s) 150, or further light sources, may also be part of the switchable canvas 130. Of course, the light source(s) 150 may not be configured to follow content of the displayed video, such as for a passive diffuser system, in which case the light source(s) 150 provides a single color, combination and/or sequence of colors under the control of the processor 170, as described in the above referenced International Publication Nos. WO 2006/003603 A2 and WO 2006/003604 A2, which also describe various active and passive diffuser systems where light output from the displayed content or the light source is modified or controlled in various ways to provide ambient light that follows or relates to the displayed content, such as via using various combination of sensors, electromagnetic couplers, modulators and light source(s). For example as described above, the processor 170 may be pre-programmed with defined settings selectable by the user such settings for mood (e.g., romantic) or for content type (e.g., action, comedy), or can be programmed by the user to provide a desired ambient light (e.g., color, hue, saturation, intensity) from the light source(s) 150 via any interface device, such as via a remote control, keyboard, mouse or buttons provided on the TV or LCD panel 110.

The processor 170 may be dedicated to the switchable canvas 130 or part of the television, monitor or LCD panel 110. The processor 170 may include micro-processors, central processing units (CPUs), digital signal processors (DSPs), ASICs, or any other processor(s) or controller(s) such as digital optical devices, or analog electrical circuits that perform the same functions, and employ electronic techniques and architecture. The processor 170 is typically under software control for example, and has or communicates with memory that stores the software and other data such as user preferences. The processor 170 may be configured to relate the ambient light 160 to video information displayed on the LCD panel 110.

The processor 170 may also include any intelligent device that can allow controlling directly or indirectly the light source(s) 150 so that character of the output light made therefrom changes, such as by changing any of the color, hue, saturation, intensity, or other photometric quality, e.g., specular reflection properties, retroreflective properties, etc. This may include controlling the on/off duty cycle for a plurality of light generating devices, controlling modulators, changing the luminous output of an electroluminescent device, adjusting the effectiveness of a goniophotometric element that may be located on the back and/or front faces of the switchable canvas 130, or any other modifications which change the ambient light character directly or indirectly as a function of content information signal (RF, video, audio or the like) or as a function of the image displayed on the TV, monitor or LCD panel 110.

FIG. 2 shows a device 200, such as a television, in accordance with an embodiment of the present system. The device has a processor 170 operationally coupled to a memory 210, one or more light engines or sources 150 and a user input device 220 for operation of the display device 200. The memory 210 may be any type of device for storing application data as well as other data, such as audio/visual data and ambient lighting data, such as ambient light scripts. The application data and other data are received by the processor 170 for configuring the processor 170 to perform operation acts in accordance with the present systems and methods. The operation acts include controlling the device 200 to display content and controlling the light engine(s) 150 to display ambient image portions in accordance with the present system that may be related to image content and/or may be unrelated to image content. The user input device 220 may include a keyboard, mouse, remote control and/or other device, including a touch sensitive display. The user input device 220 may be stand alone or be a part of a system like a personal computer, personal digital assistant, display device such as a television, whiteboard, etc. and operate for communicating with the processor 170 via any type of link, such as a wired or wireless link.

The methods of the present system are particularly suited to be carried out by a computer software program, such computer software program preferably containing modules corresponding to individual and/or composite steps or acts. Such software may of course be embodied in a computer-readable medium, such as an integrated chip, a peripheral device or memory, such as the memory 210 or other memory coupled to the processor 170.

The memory 210 may also store an ambient effect script for producing the ambient image portions in synchronization with rendered content, such as audio/visual content, or rendered independent of content. The memory 210 configures processor 170 to implement the methods, operational acts, and functions disclosed herein. The memories may be distributed or local and the processor 170, where additional processors may be provided, may also be distributed, as for example based within the light engines 150, or may be singular.

Further, control of the light source(s) 150 is particularly suited to be carried out by a computer software program. Such software can of course be embodied in a computer-readable medium, such as an integrated chip, a peripheral device or memory 210 coupled to the processor 170. The processor 170 is capable of providing control signals and/or performing operations in response to input signals from the I/O device 220 and executing instruction stored in the memory 210. The processor 170 may be an application-specific or general-use integrated circuit(s). Further, the processor 170 may be a dedicated processor for performing in accordance with the present system or may be a general-purpose processor wherein only one of many functions operates for performing in accordance with the present system. The processor 170 may operate utilizing a program portion, multiple program segments, or may be a hardware device utilizing a dedicated or multi-purpose integrated circuit.

Each of the above systems for providing ambient light may be utilized in conjunction with further systems. Thus, it is to be appreciated that any one of the above embodiments or processes may be combined with one or with one or more other embodiments or processes to provide even further improvements in accordance with the present system.

Illustratively, one advantage of the switchable canvas 130 being transparent (or semi transparent) is that when the TV is off, the plate is transparent (or semi transparent) and thus does not obstruct views behind it. Additionally, the TV appears smaller or less bulky and less obtrusive than the case where the canvas 130 is not transparent. Of course, if desired, the plate may be non-transparent and act as a canvas for the ambient light, instead of the back wall acting as the canvas. Whether the switchable canvas 130 is transparent or not, the switchable canvas 130 may have interruptions and/or bubbles that reflect the ambient light 160 toward the viewer, for example, and thus act as a canvas eliminating the need for the back wall and associated disadvantages, such as the need for a proper wall color, distance and orientation of the TV in relation to the back wall, as described in above-noted U.S. Provisional Patent Application Ser. No. 60/713,184 (Docket US002308).

Of course, the switchable canvas 130 may have any shape and/or size, including shapes that provide better ambient light distribution toward the viewer. For example, the switchable canvas 130 may be limited to cover the frame of the TV, thus rendering the TV frame switchable, i.e., in the transparent state, the TV frame is visible, e.g., when the TV is in the OFF state; while in the scattering state, e.g., when the TV is in the ON state; the frame is covered or hidden behind the canvas 130 which scatters and provides ambient light 160. The user interface 220 may be configured to turn ON/OFF the switchable canvas 130 and/or the light source(s) 150 irrelevant of the state of the TV. Thus, even when the TV is ON, the user may choose to maintain the transparency of the switchable canvas 130, e.g., by maintaining or applying the proper voltage to the switchable canvas 130. Conversely, with the TV OFF, the user may chose to turn on the light source(s) 150 and switch the canvas 130 to the scattering state (no voltage applied to the canvas 130), thus providing background ambient light, which may be controllable by the user, or controlled by a script or predetermined setting, such as romantic setting and the like.

In view of the present disclosure, other modifications would be apparent to those skilled in the art. For example, the switchable canvas with at least one light source and a controller may also be used as a frame around posters, art work, and/or public/advertisement information boards, to provide a frame of any desired color, or changing colors, or be switched to the transparent state and become substantially invisible.

Finally, the above-discussion is intended to be merely illustrative of the present invention and should not be construed as limiting the appended claims to any particular embodiment or group of embodiments. Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A display system comprising:
a unit configured to provide information; and
a plate extending away from said unit in at least one direction and being configured to receive input light and to provide ambient light, said plate being substantially transparent in a transparent mode and substantially light scattering in a scattering mode to provide said ambient light.

2. The display system of claim 1, wherein said plate is switchable between said transparent mode and said scattering mode in response to a voltage.

3. The display system of claim 1, wherein said plate is in said transparent mode when a first voltage is applied and in said scattering mode when a second voltage is applied.

4. The display system of claim 3, wherein said first voltage is higher than said second voltage.

5. The display system of claim 3, wherein said second voltage is substantially zero volts.

6. The display system of claim 1, wherein said plate is in said transparent mode in response to application of a voltage.

7. The display system of claim 1, further comprising a controller configured to relate said ambient light to said information provided by said unit.

8. The display system of claim 1, wherein said input light is provided from at least one of a light source and said information displayed on a display area of the unit.

9. The display system of claim 1, wherein said plate covers a frame of said display system.

10. The display system of claim 1, further comprising a controller and at least one light source, said controller being configured to control said at least one light source and said plate to provide said ambient light in at least one of presence and absence of said information.

11. The display system of claim 1, wherein said information is at least one of audio and video information.

12. The display system of claim 1, further comprising a diffuser located behind said plate.

13. A diffuser system comprising:
at least one light source configured to provide input light; and
a plate configured to receive said input light and to provide ambient light, said plate being substantially transparent in a transparent mode and substantially light scattering in a scattering mode to provide said ambient light.

14. The diffuser system of claim 13, further comprising a controller configured to control said at least one light source and said plate to provide said ambient light.

15. The diffuser system of claim 13, wherein said plate is switchable between said transparent mode and said scattering mode in response to a voltage.

16. The diffuser system of claim 13, wherein said plate is in said transparent mode when a first voltage is applied and in said scattering mode when a second voltage is applied.

17. A method for broadcasting ambient light around a unit comprising the acts of:
providing input light to a plate which is coupled to said unit; and
switching said plate from a transparent mode, where said plate is substantially transparent, to a scattering mode where said plate is substantially light scattering to provide said ambient light.

18. The method of claim 17, wherein the switching act includes grounding said plate to provide substantially zero volts.

19. The method of claim 17, further comprising applying a voltage to said plate to switch to said transparent mode.

20. The method of claim 17, further comprising the acts of:
outputting content from said unit; and
controlling at least one light source to provide input light to said plate for exit from said plate as said ambient light; said ambient light being related to said content.
